(19) United States
(12) Patent Application Publication
(10) Pub. No.: US 2024/0005556 A1
(43) Pub. Date: Jan. 4, 2024

(54) SYSTEM AND METHOD FOR ASSESSING IMAGED OBJECT LOCATION

(71) Applicant: BUILDOTS LTD., Tel Aviv (IL)

(72) Inventors: Yakir Sudry, Ramat Gan (IL); Roy Danon, Tel Aviv (IL)

(21) Appl. No.: 17/926,596

(22) PCT Filed: May 21, 2021
(86) PCT No.: PCT/IL2021/050590

§ 371 Date: Nov. 20, 2022

Related U.S. Application Data
(60) Provisional application No. 63/028,545, filed on May 21, 2020.

(51) Int. Cl. G06T 7/73; G06V 10/40; G06V 20/50; G06T 7/80

(52) U.S. Cl. CPC G06T 7/75; G06V 10/40; G06V 20/50; G06T 7/80; G06Q 50/08

(57) ABSTRACT

Provided herewith a computer-based method for assessing a location of an object-of-interest (OBIN) in a building site. The method may comprise: acquiring an image of an OBIN captured by an image capturing device (ICD) within the building site; acquiring a position and orientation of the ICD at the time the image was captured; processing the image to identify an observed reference point of the OBIN on the image; and determining spatial coordinates for the observed reference point with respect to the model. Alternatively, the method may comprise: acquiring an image of a building site captured by an ICD; acquiring a position and orientation of the ICD at the time the image was captured; determining an expected position on the image for an object based on a model of the building site; determining an image-based-position of the object; and detecting a discrepancy between the expected position and the image-based position.

### RELATED APPLICATIONS

This application claims benefit under 35 U.S.C. 119(e) of U.S. Provisional Application 63/028,545 filed May 21, 2020 the disclosure of which is incorporated herein by reference.

### BACKGROUND

Typically, a building is built in accordance with an architectural model and design specifications, including specifications for, by way of example, electrical wiring, air conditioning, kitchen appliances, and plumbing, that represent the building to be completed. A “building”, as used herein, refers to any of various manmade structures and comprises, by way of example, residential buildings such as single-unit detached houses or residential towers, commercial buildings, warehouses, manufacturing facilities, and infrastructure facilities such as bridges, ports, and tunnels. Modern architectural models, especially for large building projects are typically comprehensive digital representations of physical and functional characteristics of the facility to be built, which may be referred to in the art as Building Information Models (BIM), Virtual Buildings, or Integrated Project Models. For convenience of presentation, a BIM, as used herein, will refer generically to a digital representation of a building that comprises sufficient information to represent, and generate two-dimensional (2D) or three-dimensional (3D) representations of, portions of the building as well as its various components, including by way of example: structural supports, flooring, walls, windows, doors, roofing, plumbing, and electrical wiring.

### SUMMARY

An aspect of an embodiment of the disclosure relates to providing a system, hereinafter also referred to as “a BuildMonitor system”, which operates to track, optionally in real time, a state of a building under construction or a constructed building.

A BuildMonitor system in accordance with an embodiment of the disclosure comprises a “Model Awareness module” (“MAM”) that operates to assess installation of objects in a building site to determine if a given object was installed in accordance with a BIM representing the building site, and optionally update the BIM to reflect a current state of the building site and objects therein.

In an embodiment, a BuildMonitor system comprises an optionally cloud based, data monitoring and processing hub comprising or operatively connected to the MAM as well as a plurality of network-connected image acquisition devices, which may be referred to herein as “Site-Trackers”, that can be placed in a building site and are operable to communicate with the hub through a communication network, to capture, process, and transmit images captured from the building site to the hub.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1A schematically shows a plurality of buildings monitored by a BuildMonitor system comprising cloud-based data monitoring and processing hub and a plurality of Site-Monitors in accordance with an embodiment of the disclosure;

FIG. 1B schematically shows a room in a building shown in FIG. 1A being monitored by Site-Trackers in accordance with an embodiment of the disclosure;

FIG. 2 shows a flow diagram describing an Object Checker process in accordance with an embodiment of the disclosure;

FIG. 3 schematically shows an example image captured by a Site-Monitor comprising ROIs surrounding expected locations of objects in accordance with an embodiment of the disclosure;

FIG. 4 schematically shows an ROI of the captured image shown in FIG. 3 in accordance with an embodiment of the disclosure;

FIG. 5A—FIG. 5B schematically show simplified images indicating, respectively, IPCs of the electric outlet shown in FIG. 4;

FIG. 6A-FIG. 6B schematically shows IPCs of the electric outlet as shown in FIG. 5A-FIG. 5B respectively, overlaid with an expected location of the electric outlet;

FIG. 7 shows a flow diagram describing an Object Locator process in accordance with an embodiment of the disclosure;

FIG. 8A-FIG. 8C schematically shows ROIs from three different images of an electrical outlet captured from different perspectives, as selected during an Object Locator process in accordance with an embodiment of the disclosure;

FIG. 9A-FIG. 9C shows the ROIs shown in FIG. 8A—FIG. 8C respectively overlaid with edges of the electric outlet as determined by an appropriate detector in accordance with an embodiment of the disclosure;

FIG. 10 schematically shows an observed RP_{BIM} of the electrical outlet within a 3D environment in a BIM frame as determined in an Object Locator process in accordance with an embodiment of the disclosure;

FIG. 11 schematically shows an observed RP_{BIM} of the electrical outlet within a 3D environment in a BIM frame as determined through a “depth-estimation method” in accordance with an embodiment of the disclosure;

FIG. 12 schematically shows an observed RP_{BIM} of the electrical outlet within a 3D environment in a BIM frame as determined through a “triangulation method” in accordance with an embodiment of the disclosure;

### DETAILED DESCRIPTION

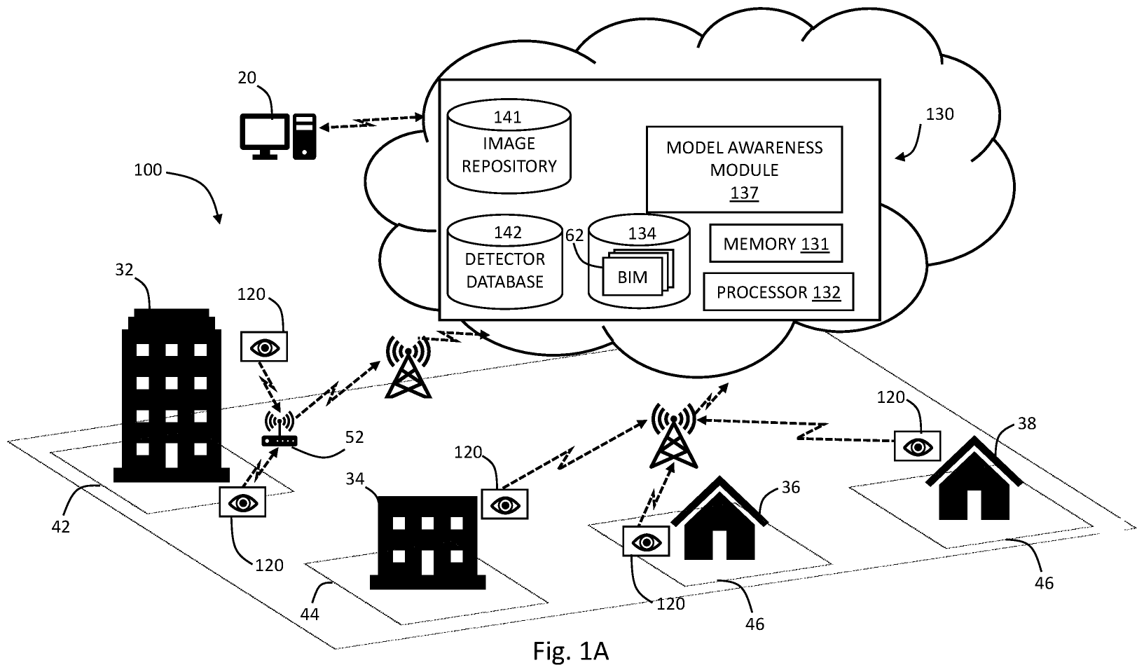

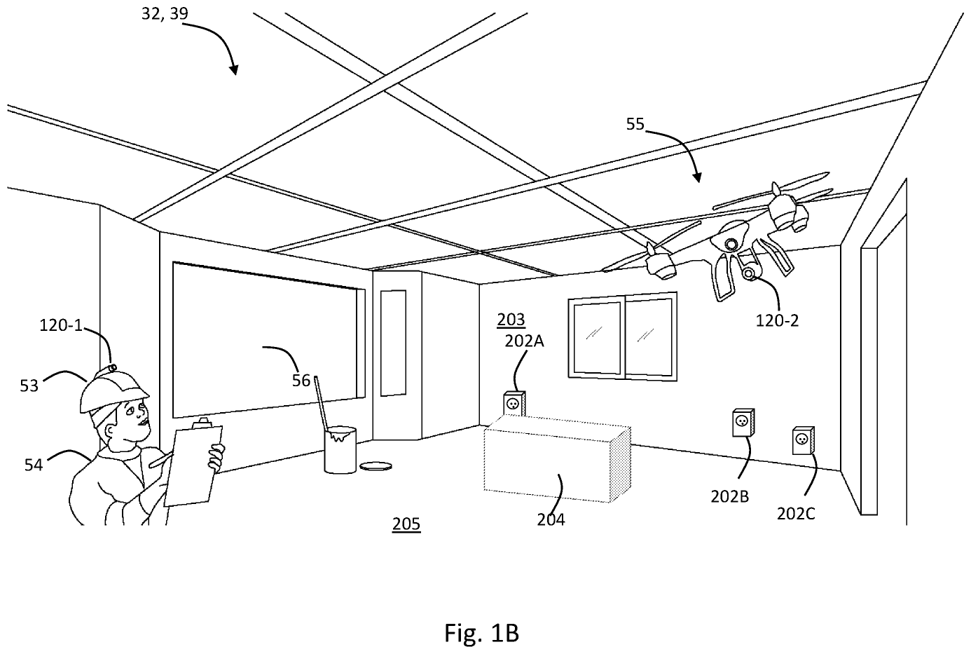

In the following detailed description, components of a BuildMonitor system in accordance with an embodiment of the disclosure operating to track progress of one or more building projects are discussed with reference to FIG. 1A. FIG. 1B schematically shows Site-Trackers monitoring a building project. Operation of Site-trackers, as well as a MAM comprised in a BuildMonitor system in accordance with an embodiment of the disclosure are discussed with reference to those and other figures.

Reference is made to FIG. 1A, which schematically shows a perspective view of a BuildMonitor system 100, operating to track a current state of a plurality of buildings, respectively, a first office tower 32 in a building site 42, a second office tower 34 in a building site 44, a first house 36 in a building site 46, and a second house 38 in a building site 48.

BuildMonitor system 100 optionally comprises a data monitoring and processing hub 130 that may, as shown in FIG. 1A, be cloud based, and a plurality of Site-Trackers 120 located at building sites 42, 44, 46, 48. In FIG. 1A, for convenience of presentation and to accommodate constraints on sizes of images shown in the figures, one or two Site-Monitors are shown over or on the buildings at the respective building site. However, Site-Trackers 120 can be located inside a building, and each building may, depending on the size of the building, have by way of example dozens of Site-Monitors monitoring different portions of the building.

Hub 130 optionally has a memory 131 and a processor 132, and/or any combination of hardware and software components, including one or more virtual entities, configured to support functionalities of the hub. Hub 130 optionally comprises a MAM 137 that operates to assess installation of objects in a building site to determine if a given object was installed in accordance with a BIM representing the building site, and optionally update the BIM to reflect a current state of the building site and objects therein. Optionally, MAM 137 operates in accordance with a set of instructions and/or data (which may be referred to in the aggregate as “software”) optionally stored in memory 131 and executed by processer 132.

By way of example, a property management company contracted to manage office tower 32 has access to a BIM 62 that represents office tower 32. Examples of BIMs includes model created using software platforms for building design that are known in the art, such as Revit® (by AutoDesk®), ArchiCAD® (by Graphisoft®), and FreeCAD®. The property management company, wanting MAM 137 to assess proper construction of office tower 32 in accordance with BIM 62, submits a copy of BIM 62 to hub 130 for storage in a BIM database 134 (as shown in FIG. 1A), or alternatively grants MAM 137 access to a copy of BIM 62 stored elsewhere. BIM data base 134 may store respective BIMs for other buildings as well, including second office tower 34, first house 36, and a second house 38.

Hub 130 optionally comprises an image repository 141 comprising images captured from the buildings monitored by MAM 137. Optionally, images stored in image repository 141 are respectively stored with an associated location of where the image was captured. The associated image location optionally includes one more of an identity of the building in which the image was captured and spatial coordinates for the position and orientation of an image capture device (ICD), by way of example comprised in a Site-Tracker, at the time it captured the image. Optionally, the position and orientation are with respect to the BIM that models the building. By way of example, image repository may store a plurality of images captured from various rooms in office tower 32, with each image being stored with an associated set of spatial coordinates for a position and orientation with respect to BIM 32. Optionally, the images stored in image repository 141 are captured by Site-Trackers 120, as described hereinbelow.

Site-Trackers 120 are configured to transmit images they acquire from building sites they monitor to hub 130. The Site-Trackers may transmit images as captured to the hub, and/or as processed locally before forwarding the processed images to the hub. Optionally, BuildMonitor system 100 comprises one or more aggregator devices 52 that receives data from one or more Site-Trackers 120 at a given building site and forward the received data to hub 130. Aggregator device 52 optionally forwards data as received, and/or as processed by the aggregator device.

Site-Tracker 120 comprises an image capture device (ICD) for capturing images of a building site, which may be, by way of example, an optical imaging device (a camera); a LIDAR-based imaging device, a sonic imaging device, and a radio-wave-based imaging device. The camera may be operable to capture panoramic images, optionally 360-degree images. Site-Tracker 120 may comprise one or more of: a data storage device configured to store images captured by the image capture device, a wireless communication module configured to transmit information including images captured by the image capturing device to an external device, by way of example, hub 130, and a position tracking device for tracking movement and position of itself. The position tracking device may comprise one or more of: a Global Positioning System (GPS) tracking device, a barometer, and an inertial measurement unit (IMU). Site tracker 120 may further comprise a data port to establish a wired connection with a communications network, through which images stored in the data storage device may be transmitted to an external device such as hub 130. Site Tracker 120 further comprises a processing unit and a memory storing a set of instructions, wherein the processing unit operates and/or coordinates activities of any one or more of the image capturing device, the wireless communication module, the position tracking device, and the data storage device.

Optionally, Site-Tracker 120 comprises or is comprised in a smartphone. The Site-Tracker may be mounted on a wearable equipment to be worn by a human operator at a building site. By way of example, the wearable example may be a helmet, or a harness configured to secure the Site-Tracker onto the human operator's arm or chest. Alternatively, the Site-Tracker may be mounted on a ground or aerial vehicle that is remotely operated by a user or autonomously controlled.

Reference is made to FIG. 1B schematically showing two exemplary Site-Trackers monitoring a room 39 comprised in office tower 32 (FIG. 1A). A first Site-Tracker 120-1 is mounted on a helmet 53 worn by a maintenance worker 54, and a second Site-Tracker 120-2 is mounted on a quadcopter 55. Images captured by the ICD respectively comprised in Site-Trackers 120-1 and 120-2 can be used by BuildMonitor 100 to automatically track in real time the status of room 39 and more generally the status of all the rooms, hallways, and other portions of office tower 32.

A selection of frames of a video captured in a building site by a camera mounted on a Site-Tracker may be associated with spatial coordinates for a pose (position and orientation) of the camera within office tower 32. The resulting set of camera poses (CPs) may be used to create a detailed route map that is keyed to the captured video footage. The pose of the ICD stored with each captured image may be a pose (“BIM pose”) that is with respect to spatial coordinates within the building site as represented in BIM 68. The BIM pose may be determined based on spatially relevant signals available to the ICD at the building site, such as GNSS, WiFi, and cell towers. Separately or in combination with the spatially relevant signals, the BIM pose may also be determined based on analyzing the image or video captured by the ICD together with known location information of the building site or features within the building site. One exemplary method of accurately determining a BIM pose of an ICD based on an analysis of images captured at a building site and a corresponding BIM is provided by way of example in international patent publication WO 2020/202164 A2.

Typically, a BIM represents a building as originally planned. However, a completed building may in reality have many features that deviate from the BIM due to many reasons such as availability of materials or lack thereof during constructions, intentional changes to the original building plan during construction, intentional deviations from the building plan by construction personnel, errors in the BIM that were uncovered during implementation, human error by construction personnel, and modifications or repairs subsequent to building completion. Having a repository of images captured from a building site, with each image associated with time of capture and a CP with respect to the building's BIM makes it possible to compare the expected position of objects as modeled in the BIM against an actual state of the building as observed.

For convenience of presentation, objects in a building site as represented in the BIM may be referred to herein as “BIM objects” in order to differentiate them from the actual objects at the real world building site, and a set of coordinates (x, y, z) within a 3D environment of the building site as represented in the BIM may be referred to herein as “BIM coordinates” in order to differentiate them from the real world coordinates (X, Y, Z) of actual objects in the corresponding building sites as well as from “pixel coordinates” (x′, y′) within a 2D image.

In an embodiment of the disclosure, it is possible to project a given location defined by BIM coordinates (x, y, z) within the BIM into pixel coordinates (x′, y′) within an image captured in a building site provided that a CP of the image with respect to site's BIM is known. Conversely, in an embodiment of the disclosure, determining the CP for an image captured in the building allows for transposition of pixel coordinates (x′, y′) of an image into BIM coordinates (x, y, z) within the 3D representation of the building, provided that a distance D between the CP and a reference point (“RP”) of the imaged object can be determined. Distance D may be determined in a number of ways, such as triangulation using the CP of multiple images of the same object from different perspectives. By way of example, a position of an object in the building site can be estimated based on analysis two or more images of the object captured by a camera, provided that the respective CPs associated with the images are known.

Through such processes as well as others, images of a building site in which each image is associated with a CP, collected by way of example by one or more Site-Trackers 120, may be used to detect objects installed within the building site during or after construction in a way that is not in accordance with a BIM of the site.

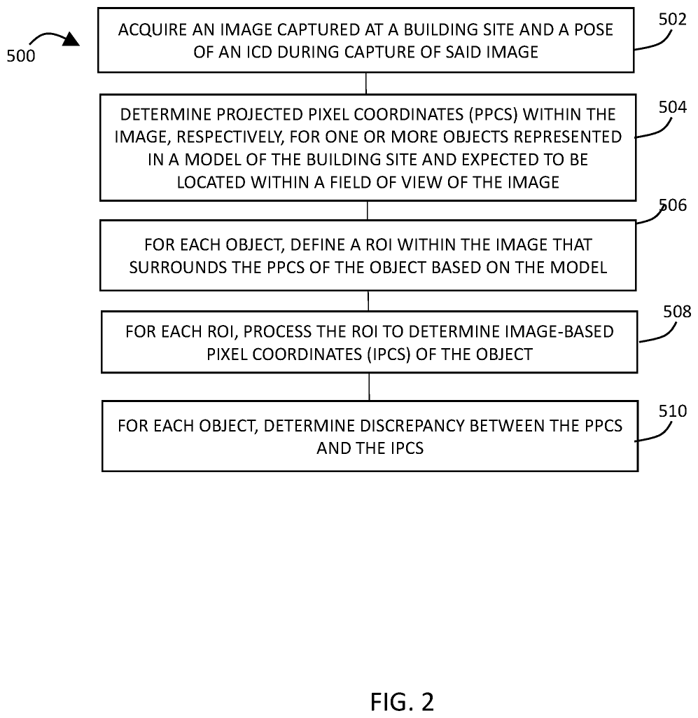

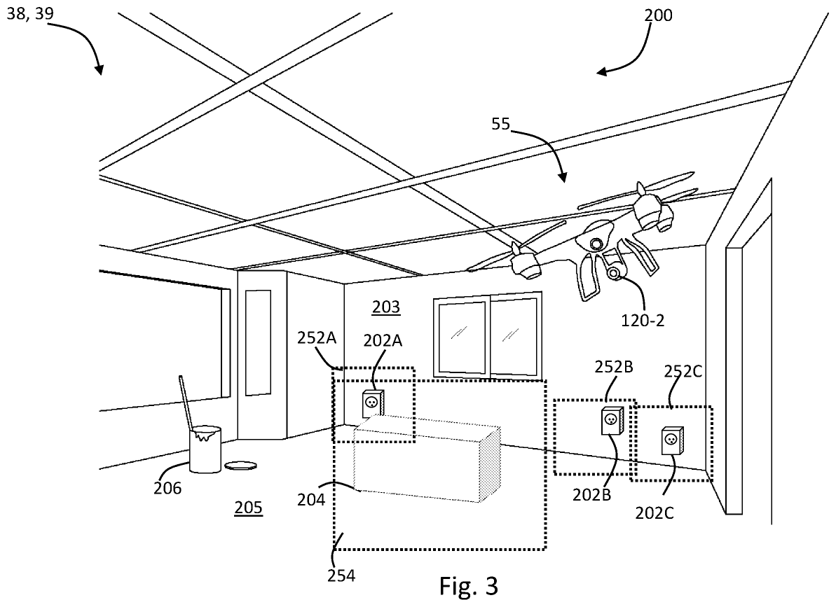

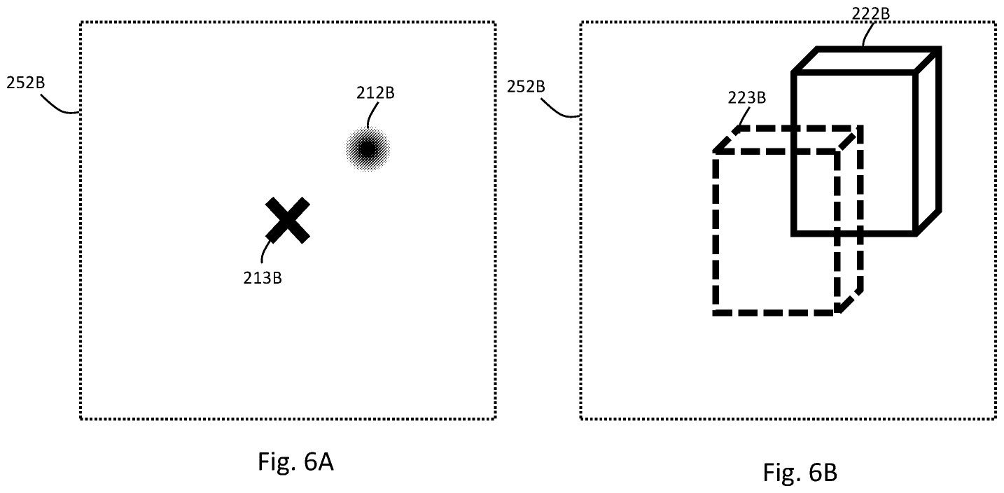

Reference is made to FIG. 2, which shows a flow diagram 500 describing an Object Checker method performed by MAM 137 in accordance with an embodiment of the disclosure. Aspects of the Object Checker method will also be schematically illustrated in FIG. 3-FIG. 5???, FIG. 6A and FIG. 6B, as described herein below.

In a block 502, MAM 137 acquires an image captured in a building site and an associated CP of the camera that captured the image. Optionally, the image is an image previously captured by a Site-Tracker, optionally as part of a video footage, and stored in image repository 141, then subsequently retrieved by the MAM from the image repository. An image may be selected for retrieved based optionally on a selection of a particular building site within a building for checking by a user of the module. By way of example, a user wishing to assess room 39 of building 32 manually selects the room for assessment through a user interface, optionally in terminal 20. Optionally, the room is selected based on a pre-arranged or automated assessment schedule. Optionally, new images captured by a Site-Tracker and stored in image repository 141 enter a queue for processing by the MAM.

FIG. 3 shows an example image 200 retrieved by MAM 137, which is of room 39 in office tower 32 as captured by Site-Tracker 120-1 mounted on maintenance worker 54 (site-Tracker 120-1 and maintenance worker 54 is shown in FIG. 1B). The image shows objects in room 39 within the field-of-view (FOV) of the ICD comprised in Site-Tracker 120-1 at the time of image capture, including electrical outlets 202A-C and kitchen island 204. Site-Tracker 120-2 mounted on quadcopter 55 that was also monitoring room 39 is within the FOV as well at the time of image capture.

Images stored in image repository 141 may be stored with image metadata regarding the image and the ICD that captured the image, such as a time of capture, the building site where the image was captured, a pose of the ICD within the building site at the time of capture, and intrinsic parameters of the ICD that determine mapping between coordinates in a camera frame and pixel coordinates in an image. The intrinsic parameters may be based on the ICD's optical characteristics (such as focal length and lens characteristics) and image digitization protocols during image capture. The pose and intrinsic parameters of the ICD may be used by the MAM to make associations and comparisons between features in the image captured by the ICD in the building site and objects represented in a BIM of the building site. The pose of the ICD stored with each captured image may be a BIM pose that is with respect to spatial coordinates within the building site as represented in the BIM.

In a block 504, MAM 137 projects BIM objects represented in the BIM for room 39 onto image 200, based on the pose and intrinsic parameters of the ICD associated with the image, as well as the object's BIM coordinates, to determine which BIM objects are within the FOV of image 200. By way of example, MAM may process a set of coordinates (“BIM coordinates”) within a 3D environment of room 39 as represented in the BIM of electrical outlet 202B together with the ICD pose and intrinsic features associated with image 200 to determine projected pixel coordinates (“PPCs”) of how the electrical outlet would be expected to appear within the FOV and 2D frame of image 200.

MAM 137 may determine and/or maintain for image 200 a set of object feature vectors OFVs, each OFV comprising parameters regarding one of the BIM objects expected to be within the FOV of the image. Each OFV may include components ofvᵢ 1≤i≤I such that OFV={ofv₁, ofv₂, . . . , ofv_{I}}, where {ofvᵢ} comprises BIM coordinates of the object as represented in the BIM, PPCs of the BIM object as projected onto image 200, an expected distance between the ICD and the object, and expected visual angle of the object in the image, image features such as level of focus, brightness, and contrast, and object details such as BIM object name or category based on BIM metadata. It will be appreciated that a BIM typically includes metadata regarding an identity of objects represented in the model. By way of example, a representation of an electrical outlet in the BIM may be associated with metadata in the BIM identifying the BIM object as an electrical outlet. In a case where a BIM is presented without such BIM object metadata, MAM 137 may flag the BIM as insufficient and provide instructions to a user to provide such metadata before proceeding, or to import or access a different BIM that includes the object metadata.

In a block 506, MAM 137 determines, for each BIM object determined to be within the image FOV, a region-of-interest (ROI) that encompasses the PPCs of the respective BIM object within the image. By way of example as shown in FIG. 3, MAM 137 projects the positions for each of electrical outlets 202A-C and kitchen island 204 as modeled in BIM 62 onto image 200 and define ROIs around them for further analysis. As shown in FIG. 3, the model defines an ROI schematically illustrated as a dotted rectangle 252A that encompasses a field of view that includes the PPCs of electric socket 202A. FIG. 3 shows an ROI schematically illustrated as a dotted rectangle 252B that encompasses a field of view that includes the PPCs of socket 202B, an ROI schematically illustrated as a dotted rectangle 252C that encompasses a field of view that includes the PPCs of electric socket 202C, and an ROI schematically illustrated as a dotted rectangle 254 that encompasses a field of view that includes PPCs of kitchen table 204. The dimensions of the ROI may depend on various features of the object, including features comprised in the corresponding OFV of the BIM object. By way of example, an BIM object estimated as having a larger visual angle and thus expected to take up a larger portion of the FOV of the image would be assigned a larger-dimensioned ROI. Other objects that are in room 39 at the time of image capture, but are not represented in BIM 62, such as drone 55 and trash can 206, may not be included for ROI generation or for further analysis.

In a block 508, MAM 137 processes the respective ROIs to detect the object expected to be within the ROI's field of view and if present determine image-based pixel coordinates (“IPCs”) of the object. IPCs may define a set of pixels showing the object or an aspect thereof. By way of example, IPCs may define pixels corresponding to the entire region or an outline of the object as shown in the image.

The image processing performed on the respective ROIs as noted above may make use of “classical” computer vision algorithms that do not make use of neural networks, and alternatively or additionally make use of machine-learning (“ML”) computer vision algorithms that make use of a trained neural network, which may be a deep neural network. For convenience of presentation, a classical or ML computer vision algorithm designated for detecting an object within an ROI with respect to block 510 may be referred to generically as a “detector”.

For each ROI, MAM 137 may select one or more detectors for evaluating the ROI based optionally on aspects of the BIM object being detected and the image. BuildMonitor 130 may comprises a detector database 142 storing a plurality of detectors (which may be referred to herein as a “detector pool”).

The one or more detectors may be manually selected responsive to instructions from a user, and/or determined through a set of predetermined rules responsive to one or more object features. The object features may be stored as components ofvᵢ in the OFV characterizing the object, and may include, by way of example, BIM object name or category, expected visual angle of the object (some detectors may be configured to detect a relatively close-up view of a given object and other may be configured to detect a relatively distant view), and features characterizing the image such as brightness (some detectors may be configured detect an object in relatively bright conditions or alternatively in relatively low-light conditions).

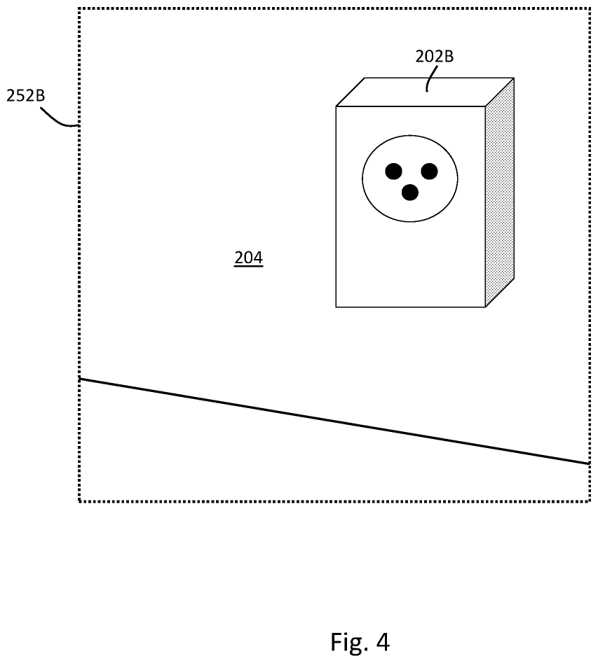

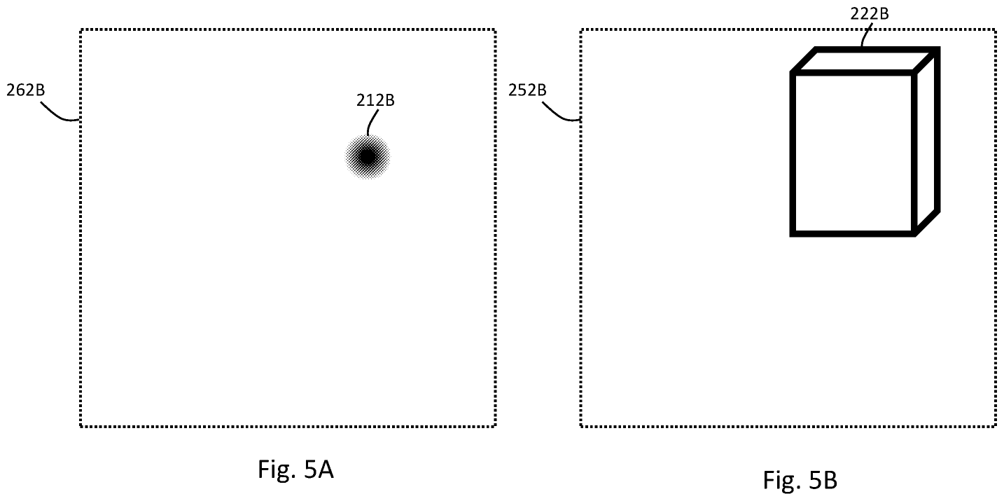

By way of example, FIG. 4 schematically shows a portion of image 200 that is bounded by ROI 252B, which, according to the BIM, is expected to include a view of electric outlet 202B. ROI 252B may be processed so that the image of electric outlet 202B is converted into a simplified image indicating an image-based position of the electrical outlet. By way of example (not shown), the image-based position may comprise a coordinate indicating center of mass of electrical outlet 202B. As shown in FIG. 5A, the simplified image indicating the IPCs of electric outlet 202B may be, by way of example, a circular region 212B in which the darkness of the regions indicates likelihood of the point being a center of mass for electrical outlet 202B. As shown in FIG. 5B, the simplified image indicating the IPCs may be, by way of another example, an outline 222B indicating the edges of electrical outlet 202B.

In a block 510, MAM 137 compares the PPCs of the object based on the BIM coordinates against an the IPCs of the object based on the image to determine whether or not there is a discrepancy in the “expected” position of the object as defined by the PPCs and the “actual” position of the object as defined by the IPCs. The comparison may be based on, by way of example, a degree of pixel overlap between the PPCs and the IPCs. Whether or not the discrepancy is significant may be based on one or more assessment tolerance values assigned to the object. The assessment tolerance values may be manually set by a user, and/or determined through a set of predetermined rules responsive to one or more object features. The object features used in determining the assessment tolerance values may be stored as components ofvᵢ in the OFV characterizing the object, and may include, by way of example, BIM object identity (some objects, such as pipes or electrical outlets that require interconnecting with other objects, may require a higher degree of accuracy for its position), room geometry (smaller rooms may require higher accuracy), dimensions of the object (smaller object may require higher accuracy), expected distance of the object, expected visual angle of the object, and presence of other interfering objects nearby.

FIG. 6A schematically shows ROI 252B displaying IPCs of electric outlet 202B as a center of mass 212B and displaying the electric outlet's PPCs as a projection, schematically indicated as an “X” symbol 213B, of a center of mass based on BIM coordinates of the electric outlet as represented in BIM 62 that models room 39. It will be appreciated that, as shown in FIG. 6A, there is substantial discrepancy between image-based center of mass 212B and the BIM-based center of mass 213B.

FIG. 6B shows an alternative comparison, between IPCs 222B of electrical outlet 202B that was generated by a detector configured to detect an outline and PPCs 223B of the electric outlet, which is displayed as a projection of an outline based on the BIM coordinates of the electric outlet as represented in BIM 62. It will be appreciated that, as shown in FIG. 6B, there is substantial discrepancy between the image-based outline 222B and the BIM-based outline 223B.

In light of the discrepancy, MAM 137 may designate object 202B as an object that may have been mis-installed. Optionally, MAM 137 may designate the OBIN as being appropriate for more in-depth assessment of its location, optionally through an embodiment of an Object Locator method as described with reference to flow diagram 600 herein.

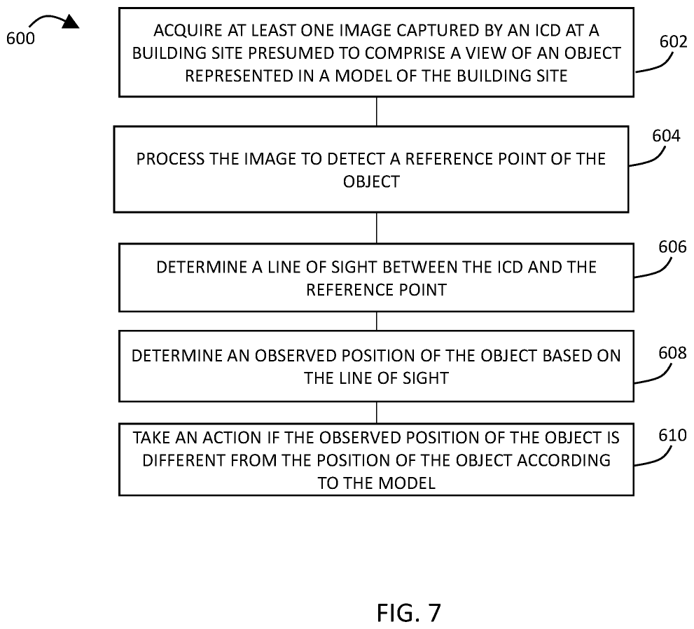

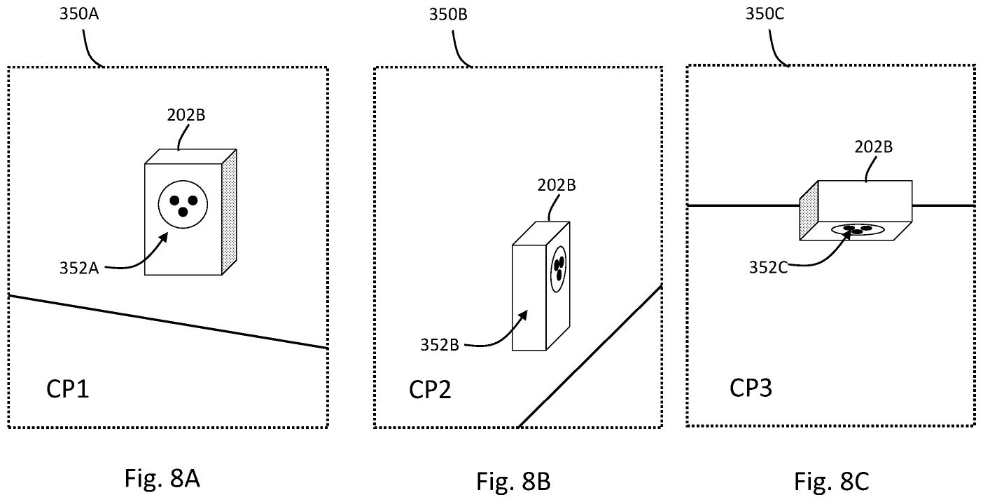

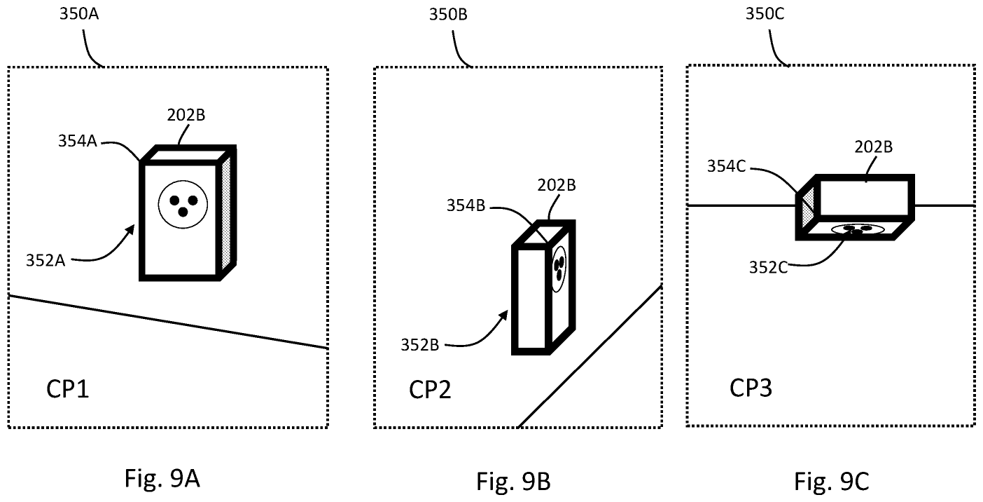

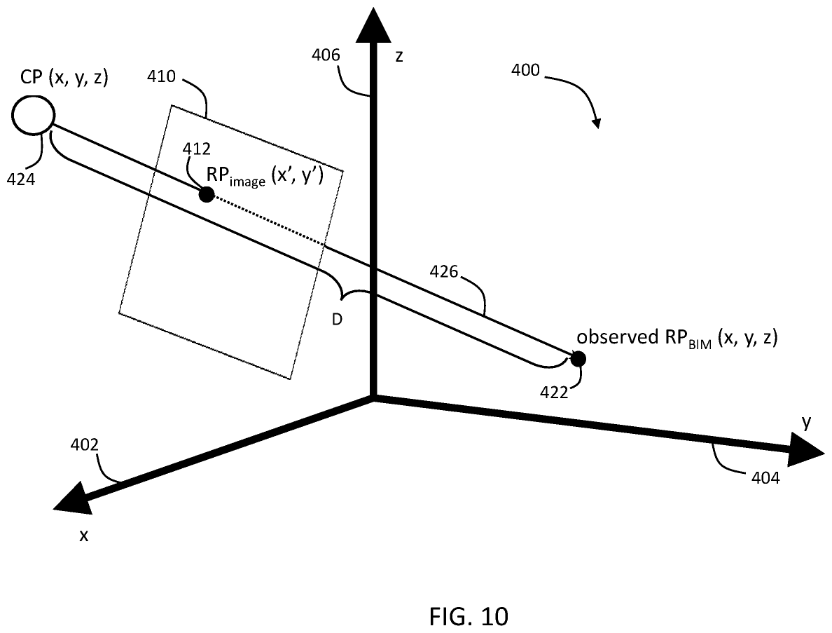

Reference is made to FIG. 7, which shows a flow diagram 600 describing an Object Locator method that may be performed by MAM 137 in accordance with an embodiment of the disclosure. Aspects of the Object Locator method will also be schematically illustrated in FIG. 8A-FIG. 8C, FIG. 9A-FIG. 9C, and FIG. 10-FIG. 12 as described herein below. An Object Locator method, an embodiment of which is described hereinbelow, determines BIM coordinates of an object in a building site, responsive to one or more images of the object captured by an ICD in the building site.

As noted with respect to Object Checker method 500, it is possible to project, onto a 2D image of a building site, a given location of an object defined by 3D spatial coordinates within a BIM of the building site, provided that a CP of the ICD that captured the image is known. However, transposing an object position in the other direction, from pixel coordinates within a 2D image frame to BIM coordinates within a 3D space as modeled in the BIM requires additional information. Given a CP at which an image was captured, a line-of-sight directed from the CP towards a given object displayed in the image may be defined. However, in order to determine 3D coordinates from the line-of-sight, additional information is required to determine a distance along the line of sight between the CP and the object.

A building site typically comprises many objects, and a BIM modeling the building site also typically comprises a representation of those many objects. A given building site may be associated with an “object set” comprising a plurality of BIM objects designated to have their respective locations withing the building site be intermittently assessed through Object Locator method 600. Optionally, when a new image or a video of the building site is captured and made available to the MAM, the module may assess location of the BIM objects in the object set based on the newly captures image or video. By way of another example, an object to be evaluated by Object Locator method 600 may have been previously designated as being a misplaced OBIN in accordance with Object Checker method 500 as described herein above.

Whereas the description of Object Locator method 600 herein below refers generally to assessing a position of a single BIM object, it will be appreciated the method may be applied to a plurality of BIM objects that are similarly assessed, in series and/or in parallel.

In a block 602, MAM 137 acquires, optionally from image repository 141, at least one image captured by an ICDs at a building site that is presumed to comprise a view of a BIM object.

Images stored in image repository 141 may be stored with image metadata regarding the image and the ICD that captured the image, such as a time of capture, the building site where the image was captured, a camera pose (CP) of the ICD within the building site at the time of capture, and intrinsic parameters of the ICD that determine mapping between coordinates in a camera frame and pixel coordinates in an image. The intrinsic parameters may be based on the ICD's optical characteristics (such as focal length and lens characteristics) and image digitization protocols during image capture. The pose of the ICD stored with each captured image may be a BIM pose that is with respect to spatial coordinates within the building site as represented in the BIM. The pose and intrinsic parameters of the ICD may be used by the MAM to make spatial associations and comparisons between pixel coordinates of features in the image captured by the ICD in the building site and BIM coordinates of BIM objects as represented in the BIM of the building site.

MAM 137 may generate and/or maintain, for each of a plurality of BIM objects in an object set, an object feature vector OFVⱼ 1≤j≤J, J being the number of BIM objects in the object set. Each OFVⱼ may comprise components ofvᵢ 1≤i≤I such that OFVⱼ={ofvⱼ₁, ofvⱼ₂, . . . , ofv_{jI}}, where {ofvⱼᵢ} comprises object features regarding the respective BIM object that may be used by the MAM to select appropriate images for processing to detect the BIM object. Object features may include features derived from the BIM, such as a building site that comprises the BIM object, BIM coordinates of the object within the building site, and a BIM object name or category. Other features may include image features that represent predetermined image parameters that may indicate a prospective image as being favorable for detecting the BIM object, such as a range of brightness, a range of contrast, or a set of preferred CPs. A preferred CP may be a CP of a prospective image that would be expected, based on the BIM and intrinsic features of an ICD, to provide a view of the BIM object that is at a preferred distance, in a preferred perspective, and not obstructed by other BIM objects.

MAM 137 may generate and/or maintain, for each image acquired in block 602, an image feature vector IFVⱼ 1≤j≤J, J being the number of images in an image set, by way of example, a piece of video footage. Each IFVⱼ may comprise components ifvᵢ 1≤i≤I such that IFVⱼ={ifvⱼ₁, ifvⱼ₂, . . . , ifv_{jI}}, where {ifvⱼᵢ} comprises features regarding the respective image that may be used by the MAM to determine if the image is appropriate for processing to detect the BIM object. Image features may include core image features such as the building site where the image was captured, time of image capture, a CP of the ICD within the building site at the time of image capture, intrinsic ICD features, brightness, contrast, and the like. Image features may include other features that may be computationally derived from one or more core image features in combination with features from a BIM representing the building site, such as BIM coordinates (“viewable BIM coordinates”) of the image that are encompassed within a perspective view volume of the ICD for the image. The perspective view volume may be bound by front and back clipping planes based on the ICD depth of field.

Given an object set comprising BIM objects characterized respectively by a set of OFVs and a piece of video footage comprising images characterized respectively by a set of IFVs, the MAM may process various pairs of OFVs and IFVs to select, respectively for each BIM object in the object set, one or more images that are expected to contain a view of the BIM image at a preferred viewing distance and perspective, and preferred image parameters for processing. Optionally, each of the plurality of images are cropped to keep only an ROI that includes the presumed view of the BIM object for further analysis.

By way of example, FIG. 8A-FIG. 0 schematically show ROIs 350A-C from three different images, respectively, of electrical outlet 202B (as shown in FIG. 3) selected by the MAM. Each of the three images were captured at different imaging perspectives from three different CPs: a first CP (“CP1”) for ROI 350A, a second CP (“CP2”) for ROI 350B, and a third CP (“CP3”) for ROI 350C.

In a block 604, the MAM processes the at least one image acquired in block 602 to detect the BIM object presumed to be shown in the image and determine IPCs (x′, y′) for a reference point (“RP_{image}”) of the object in the image. The RP_{image} may be a predetermined portion or aspect of the object as imaged in the image, by way of example a face, edge, or vertex of the object, a center of a given face of the object, or a center of mass of the object.

The image processing performed on the respective ROIs to detect the RP_{image} may be based on “classical” computer vision algorithms that do not make use of neural networks, and alternatively or additionally may be based on ML computer vision algorithms that make use of a trained neural network, which may be a deep neural network. For convenience of presentation, a classical or ML computer vision algorithm with respect to block 604 that is designated for and configured to detecting a RP_{image} within an ROI may be referred to generically as a “RP detector”.

Typically, there is no one general-purpose RP detector that is appropriate detecting an RP in all objects under all possible image parameters. Some RP detectors may be specialized for processing images of different objects, by way of example a light fixture, a table or an electrical socket. An RP detector may be even more specialized, and be configured to optimally process certain sub-types of a given object, or even certain models by certain manufacturers. A given RP detector may be optimized to process images having a certain range of brightness or contrast, or to process images captured from certain preferred perspectives or distances.

Therefore, the MAM may select one or more detectors from a detector pool optionally stored in detector database 142 for evaluating the ROI. The one or more detectors may be manually selected responsive to instructions from a user, and/or determined through a set of predetermined rules. The predetermined rules may be responsive to certain features of the image being processed, which may be stored as components of an IFV of the image, and/or certain features the BIM object being detected in the image, which may be stored as components of an OFV of the BIM object.

By way of example, MAM 137 may select a deep neural network-based RP detector that has been trained to process an image comprising a view of a rectangular cuboid wall-mounted electrical outlet to determine pixel coordinates corresponding to the edges and vertices of the outlet's outer casing. FIG. 9A schematically shows ROI 350A as shown in FIG. 8A further overlaid with a set of pixel coordinates defining edges 352A of electrical outlet 202B as determined by the selected RP detector analyzing ROI 350A. The RP detector may be configured to assign one of a plurality of sub-categories to the pixels, which may comprise twelve (12) edge categories and eight (8) vertex categories. The RP detector may be configured to assign one of the vertex sub-categories as being a RP_{image} for the electrical outlet. As shown in FIG. 9A, the pixel coordinates (x′, y′) of vertex 354A, which is the upper vertex that is distal to the wall and on the left side from the view facing wall, is assigned to be an RP_{image} for the electrical outlet.

FIG. 9B schematically shows ROI 350B as shown in FIG. 8B further overlaid with edges 352B and RP_{image} 354B of electrical outlet 202B as determined by the selected RP detector analyzing the image comprised in ROI 350B. FIG. 9C schematically shows ROI 350C as shown in FIG. 8C further overlaid with edges 352C and RP_{image} 354C of electrical outlet 202B as determined by the selected RP detector analyzing the image comprised ROI 350C.

Whereas FIG. 9A-FIG. 9C show the RP_{image} of electrical outlet 202B as being a particular vertex on the hull of the electrical outlet, it will be appreciated that any portion of an object may be designated as the object's RP.

FIG. 10 shows by way of example a 3D environment 400 in a frame (“BIM frame”) within a building site as represented in a BIM, having x-axis 402, y-axis 404, and z-axis 406. An RP_{image} 412 having IPCs (x′, y′) in an image plane 410 is assumed to have a corresponding observed RP_{BIM} 422 having BIM coordinates (x, y, z). A CP 424 of the image that includes a position (x, y, z) and an orientation of the ICD within the BIM frame allows for determination of an orientation of image plane 410 within 3D space 400 as well as determination of a LoS 426 that passes through CP 424 in the BIM frame, RP_{image} 412 within image plane 410, and observed RP_{BIM} 422 in the BIM frame. In order to transpose the RP_{image} TPCs (x′, y′) into the BIM frame to obtain BIM coordinates (x, y, z) for observed RP_{BIM} 422, additional information is required in the form of a distance D along LoS 426 between CP 424 and observed RP_{BIM} 422.

In a block 606, MAM 137 determines, for each of the at least one image acquired in block 602, a line-of-sight (“LoS”) that passes between the respective CP of the ICD at the time the image was captured, and the respective RP_{image} determined in block 604.

In a block 608, MAM 137 estimates BIM coordinates of an RP_{BIM} based on the least one LoS determined in block 606. A RP_{BIM} based on the at least one LoS can be estimated in a number of different methods, of which examples are provided herein below.

Typically, an object installed in a building site and modeled in a BIM is associated with other objects. By way of example, with reference to FIG. 1B, electrical outlets 202A-C are built into a wall 203, and kitchen island 206 is built on a floor 205. For convenience of presentation, a first object in a building site into which a second object is placed or installed may be referred to herein as a “host” of the second object. As such, wall 203 may be referred to herein as a host for electrical outlets 202A-C and floor 205 may be referred to as a host for kitchen island 204. In addition, the association between and object and its host may be defined by a fixed spatial relationship between the two.

In a first method, which may be referred to herein as a “depth-estimation method”, MAM 137 estimates distance D along LoS 426 between CP 424 and observed RP_{BIM} 422 of electric outlet 202B based on the LoS and BIM coordinates of a wall 203, which serves as a host of electric outlet 202B. Unlike electric outlet 202B, whose position is being interrogated in method 600, the BIM coordinates of wall 203 is assumed to be correct and serves as an anchor for determining the BIM coordinates of RP_{BIM} 422. The OFV for electric outlet 202B may include ofv components that identify a host as well as the spatial relationship between host and object.

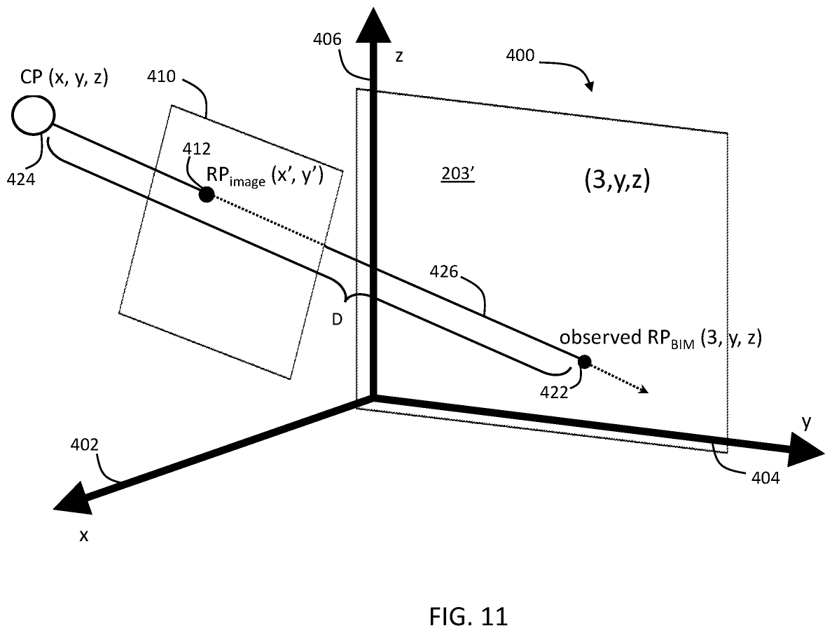

FIG. 11 is based on FIG. 10, with the addition of a representation of wall 203 in the BIM frame, which is schematically shown as a host surface 203′. For simplicity of illustration, wall surface 203′ as shown in FIG. 11 is parallel with the YZ-plane. Moreover, the vertex of electric outlet 202B detected as RP_{image} 412 is defined in the OFV for the outlet as being 3 cm out from the wall. As such, host surface 203′ is represented within the BIM frame as a plane having the BIM coordinates of (3, y, z), and observed RP_{BIM} 422 is determined as the point where LoS 426 intersects with host surface 203′.

The position of host surface 203′ may be based on the representation of wall 203 in the BIM. Alternatively, the position of host surface 203′ may be based on processing one or more images of wall 203 captured in the building site with a depth-estimation detector that is configured to produce a simplified “depth image” in which the pixel values respectively denote an estimated distance from the ICD that captured the image. The depth-estimation detector may make use of inputs a non-image-based reference such as a laser range finder or be a neural network-based detector that estimates distance based on the image itself.

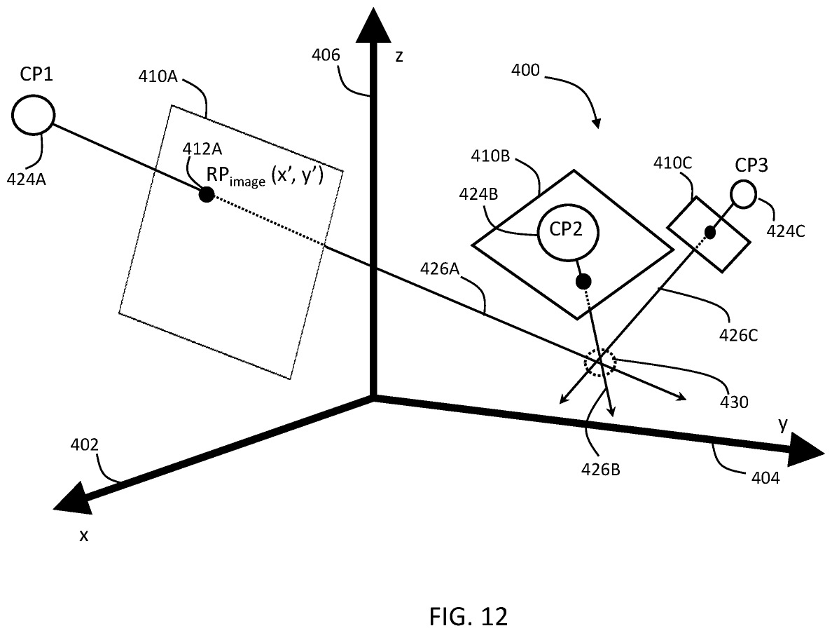

Reference is now made to FIG. 12. In a second method, which may be referred to herein as a “triangulation method”, MAM 137 determines a plurality of LoSs in the BIM frame, each LoS being based respectively on a CP and an RP_{image} for each of a plurality of images of the object captured from different perspectives, and designates the point or region where the plurality of LoSs intersect each other as comprising the BIM coordinates of the observed RP_{BIM}.

As shown in FIG. 12, MAM 137 determines by way of example three different LoSs based on three different images captured of the same object: a first LoS 426A based on IPCs (x′, y′) of RP_{image} 412A within a first image 410A that was captured by an ICD at a first CP (“CP1”); a second LoS 426B based on IPCs (x′, y′) of RP_{image} 412B within a second image 410B that was captured by the ICD at a second CP (“CP1”); and a third LoS 426C based on IPCs (x′, y′) of RP_{image} 412C within a third image 410C that was captured by the ICD at a third CP (“CP3”). The point of intersection, indicated by a dashed circle 430, between LoS 426A, LoS 426B, and LoS 426C in the BIM frame is then determined to be BIM coordinates for the observed RP_{BIM}.

In practice, the IPCs (x′, y′) of a given RP_{image} may be subject to various errors, by way of example, an error in the CP of the image, or an error by the RP detector in determining the RP from the image. Due to such errors, both the depth estimation method and the triangulation method may be subject to error. It will be appreciated that, due to the above-noted errors, the LoSs may fail to intersect, but rather converge at a region of convergence that is presumed to comprise the RP_{BIM}. The accuracy of the estimated BIM coordinates for the observed RP_{BIM} may be improved through processing more images to determine more LoSs, by way of example between 4 and 10 images from different perspectives and calculating an averaged position of the observed RP_{BIM}. The accuracy may be further improved by eliminating outlier LoSs that may be indicative of gross errors in the determination of the respective RP_{image}.

The observed RP_{BIM} as determined in block 608 may be different from the “stored RP_{BIM}” based on the BIM object as represented in the BIM.

In a block 610, MAM 137 may take an action based on a detecting a difference between of the observed RP_{BIM} and the stored RP_{BIM}. MAM 137 may update positional data of the BIM object to be in accordance with the observed RP_{BIM}. Alternatively, MAM 137 may generate an alert regarding the detection of the difference, optionally with an instruction to make a further observation of the relevant object at the building site. The alert may, by way of example, be sent a user operating the BuildMonitor system in terminal 20, to a communication device operated by a maintenance personnel at the building site, or to a Site-Tracker.

Optionally, MAM 137 may determine an RP_{BIM} for an object using both the depth-estimation method and the triangulation method, and the action taken by the MAM may be responsive to whether or not both methods produce the same or sufficiently similar BIM coordinates. By way of example, if both methods produce sufficiently similar BIM coordinates, the module may take the action of updating the positional data of the object in the BIM to reflect the updated object position. By contrast, a significant difference in the BIM position determined by the two methods may indicate presence of a more substantial structural deviation in the positioning of the object within the building site. In such a case, the module may generate an alert and instructions for further observation of the object at the building site.

There is therefore provided a computer-based method for assessing a position of an object-of-interest (OBIN) in a building site, the method comprising: acquiring at least one image of an OBIN captured by at least one image capturing device (ICD) within the building site; acquiring, respectively for each of the at least one image, a respective position and orientation of the at least one ICD at the time the at least one image was captured, the position and orientation being with respect to a model of the building site; processing the at least one image to identify an observed reference point of the OBIN on the at least one image; determining a line of sight with respect to the model connecting the ICD position and the observed reference point on the image, based on the ICD orientation; and determining, based on the line of sight, spatial coordinates for the observed reference point with respect to the model; and taking an action if the spatial coordinates for the observed reference point does not comply with the model.

In an embodiment of the disclosure, determining the spatial coordinates of the observed position comprises: acquiring spatial coordinates with respect to the model of a host object having a predetermined spatial relationship with the OBIN; and determining the spatial coordinates of the observed reference point based on the line of sight and the position of the host object. Optionally, the spatial coordinates of the host object is based on positional data of the host object as represented in the model. Optionally, the spatial coordinates of the host object comprise spatial coordinates for a surface of the host object. Optionally, the host object is a wall, optionally selected from the group consisting of a side wall, a ceiling, and a floor.

In an embodiment of the disclosure, the least one image comprises a plurality of images and determining the observed position comprises: determining a plurality of lines of sight based respectively on one of the plurality of images, each line of sight corresponding to an image from the plurality of images and connecting a ICD position for the image and a respective observed reference point determined from the image; determining a region of convergence for the plurality of lines of sight as comprising the spatial coordinates of the observed reference point.

In an embodiment of the disclosure, taking an action comprises: updating positional data of the OBIN in the model to be in accordance with the spatial coordinates of the observed reference point or sending an alert regarding a potential issue with the position of the OBIN. Optionally, the alert comprises an instruction to observe the OBIN again.

In an embodiment of the disclosure, the observed reference point of the OBIN on the at least one image is determined by processing the at least one image with one or more algorithms configured to detect the observed reference point in the at least one image. Optionally, the algorithm comprises a neural network trained to identify the observed reference point. Optionally, the one or more algorithms is selected based on one or a combination of two or more of: an object feature characterizing the object as represented in the model; an image feature characterizing the image or the ICD that captured the image; and preferred object or image parameters, respectively, for each of the one or more algorithms.

There is also provided a method for detecting an unexpected location of an object in a building site, the method comprising: acquiring an image of a building site captured by an ICD; acquiring a position and orientation of the ICD at the time the ICD captured the image; determining an expected position on the image for each of a plurality of objects, based on the spatial coordinates of the respective objects as represented in a model of the building site; defining a plurality of regions-of-interest (ROI) within the image that surrounds the expected image position of the each of the plurality of objects, respectively; processing the ROIs to determine an image-based-position of the object; and designating an object of the plurality of objects as being potentially misplaced, responsive to detecting a discrepancy between the expected position and the image-based position of the object.

In an embodiment of the disclosure, the image-based-position is determined by processing the image with one or more algorithms configured to detect the position of the object in the image. Optionally, the one or more algorithms comprise a neural network trained to identify the expected position. Optionally, the one or more algorithms is selected based on one or a combination of two or more of: an object feature characterizing the object as represented in the model; an image feature characterizing the image or the ICD that captured the image; and preferred object or image parameters, respectively, for each of the one or more algorithms.

Descriptions of embodiments are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1-16. (canceled)

17. A method of determining status of a building under construction, the method comprising:
determining a set of objects listed in a Building Information Model (BIM) for a building under construction for monitoring to determine status of the construction;
for each object in the set generating an object feature vector (OFV) comprising features characterizing an image of a region of the building;
capturing an image of a region of the building using an image capture device (ICD);
processing the captured image to determine an image feature vector (IFV) comprising features characterizing the captured image;
processing the OFV and the IFV to select the captured image for processing to detect presence of an image of the object in the captured image, and if present determine a location of the object in BIM coordinates; and
providing status of the construction based on the detected presence and determined location.

18. The method according to claim 17 wherein the features of the OFV comprise metadata features based on metadata for the object in the BIM, coordinates of the object in a BIM coordinate system, and/or features for characterizing an acquired image imaging a region of the building comprising the object.

19. The method according to claim 18 wherein the metadata features comprise a name of the object, class of objects to which the object belongs, and/or a region of the building in which the object is expected to be located.

20. The method according to claim 18 wherein the features of the OFV for characterizing the captured image comprise advantageous ranges for: distances at which the captured image is captured by the ICD and pose of the ICD.

21. The method according to claim 18 wherein the features of the OFV for characterizing a captured image comprise advantageous ranges for: focus, brightness, and/or contrast characterizing the acquired image.

22. The method according to claim 18 wherein the features of the image in the OFV comprise a set of preferred poses for the ICD.

23. The method according to claim 17 wherein the IFV features comprise: a time and pose of the ICD at which the given image was captured, intrinsic features of the ICD, and/or image pixel coordinates for the object.

24. The method according to claim 23 wherein the IFV features comprise: BIM coordinates for the object.

25. The method according to claim 17 wherein the IFV features comprise brightness, contrast, and/or distance at which the captured image was captured.

26. The method according to claim 17 comprising:
providing a plurality of detectors, each specialized for processing the OFV and/or IFV for a different set of features of the OFV and/or IFV; and
selecting at least one detector of the plurality of detectors for processing the OFV and/or IFV responsive to features of the OFV and/or IFV, and the set of features for which the detector is specialized.

27. The method according to claim 17 and comprising:
providing a plurality of ICDs for capturing images of regions of the building;
providing a hub comprising a processor for processing images captured by the ICD; and
providing a communications network via which the ICDs communicate with the hub to transmit captured images to the hub.

28. The method according to claim 27 and providing the communications network with at least one transceiver operable to receive captured images from the ICD and forward the captured images to the hub.

29. A system for determining status of a building under construction, the system comprising:
a plurality of ICDs for capturing images of regions of a building under construction;
a plurality of ICDs for capturing images of regions of the building;
a hub comprising a BIM for the building;
a communications network via which the ICDs transmit images they capture to the hub;
wherein the hub comprises hardware and/or software for processing the captured images received from the ICDs in accordance with claim 17.
